(19) United States
(12) Patent Application Publication
(10) Pub. No.: US 2005/0257573 A1
(43) Pub. Date: Nov. 24, 2005

(54) Washing machine

(76) Inventors: Heinrich Henssler, Schwaebisch Gmuend (DE); Martin Schultheiss, Schwaebish Gmuend (DE); Franz Hartmann, Schwaebisch Gmuend (DE); Albert Mertins, Pluederhausen (DE); Stephan Kraft, Marbach (DE)

Correspondence Address: WHIRLPOOL PATENTS COMPANY - MD 0750, Suite 102, 500 Renaissance Drive, St. Joseph, MI, 49085, US

(21) Appl. No.: 11/093,535

(22) Filed: Mar. 30, 2005

(30) Foreign Application Priority Data
Mar. 30, 2004 (DE) 102004016643.9

(51) Int. Cl. B08B 3/12

(52) U.S. Cl. 68/3 R

(57) ABSTRACT

A washing machine having a housing, a door in the front of the housing, and a drum located in the housing whose interior is accessible through the door. A luminous ring-shaped display element is placed around the porthole so that the user can be informed at a glance of the operating state of the machine, even if is far from the machine. The way in which the ring-shaped element is switched on (in different color or in sequence of different sectors) is indicative of the point of the washing cycle reached by the machine.

### BACKGROUND OF THE INVENTION

1. Field of the Invention

The invention relates to a washing machine having a housing, a door located in a front side of the housing, a drum in the housing whose interior is accessible through the door, and with at least one display element for providing information on the operating state of the washing machine.

The invention further relates to other large household appliances, such as clothes dryers, washer/dryers, spin dryers, etc. that have the same problems and are also the subject of this invention. When in the following the term “washing machine” is used, it is exemplary for appliances of the above-cited kind and does not restrict the scope of invention.

2. Description of the Related Art

It is generally recognized that washing machines are provided with display elements for giving information to the user on the actual operating state of the washing machine.

Washing machines share the disadvantage that the appearance of the installed washing machine is unsatisfactory because washing machines as box-shaped appliances are merely placed on the floor and look bulky and heavy. Furthermore, it is difficult to recognize the respective operating state (washing, drying, spinning, rinsing, etc.) of the known washing machines because the operating state is displayed on a small, clock-like display that can only be read from a close distance and frequently only with the help of glasses.

### SUMMARY OF THE INVENTION

The present invention relates to the task of developing a washing machine of the initially cited type to avoid the above-cited disadvantages. In particular, the operating state of the washing machine can be assessed by the user at a glance, even at a great distance from the washing machine. Furthermore, different operating states are easy to identify, and the visual appearance as well is improved. According to the invention, the housing of the washing machine is provided with at least one visual display element in the housing wall for a predetermined operating state of the washing machine. At least one display element is designed as a luminous element that can be illuminated in a predetermined color depending on the operating state to be displayed.

The advantage of this feature is that the respective operating state can be easily and clearly identified and monitored. The user of a washing machine can for example easily estimate how long the washing program has to run, whether or not the user can intervene in a specific program step, etc.

In these embodiments of the invention, it is preferable when there is a common display element for different operating states, and the common display element can be illuminated in different sectors and/or in different colors depending on the operating state to be displayed.

The advantage of this feature is that it is easier to visually perceive the display because the user always sees the same field or surface illuminated and can identify the operating state based on the sector total length or color. In this context, the common display element can be designed in various ways.

In a first embodiment, the common display element is designed as an essentially ring-shaped lighting element mounted on the door of the housing. The essentially ring-shaped lighting element preferably surrounds a window in the door. In particular, the lighting element is annular and concentrically surrounds a porthole in the door.

In a second embodiment, the common display element is located in a housing door opener.

In a third embodiment, the common display element is designed as a single lighting element near the operating and display elements of the washing machine.

In a fourth embodiment, the common display element is designed as an interior light for the drum of the washing machine.

It is alternately possible to provide different display elements for different operating states and to illuminate one of the display elements in a predetermined color depending on a predetermined operating state to be displayed.

In this alternative, there is no clear assignment of the operating state display to a specific display element; on the other hand, it can be useful in individual cases to signal different operating states with different display elements.

In this case, it is preferable for the different display elements to be designed as differently illuminable sections of a structurally unified display element, for example by designing the structurally unified display element as an essentially ring-shaped lighting element and locating it on or around a door of the housing. The sections are designed as sectors of the lighting element, especially when the lighting element is annular and is concentrically disposed around a porthole in the door.

A preferred embodiment of the invention is distinguished in that the lighting elements are supplied with light via light guides.

The advantage of this measure is that the lamp can be located in a different place than the display itself. This increases the accessibility of the lamp, which can fail from time to time and need to be replaced.

It was already stated that the invention only discloses an exemplary washing machine for the sake of clarity; however, the measures according to the invention can also be used in other, similar appliances such as dryers, washer/dryers, i.e., combined washing machines and dryers, and spin dryers.

According to another feature of the invention, the washing machine is provided with a light-guiding element in the door with an arrangement such that the light rays are guided into the drum as well as onto an area in front of the side when the doors open; when the door is closed, the light-guiding element is in front of a luminaire, and the light rays are guided through the light-guiding element into the drum.

Thanks to the above features, the interior of the drum is brightly illuminated while the washing machine is running because the light rays are directly guided into the drum, i.e. nearly in an axial direction. When the door is opened, the interior of the drum as well as the area in front of the washing machine is illuminated for loading or emptying the washing machine.

In an exemplary embodiment of the invention that can also be used independent of the other features, a housing is provided whose bottom is located at a distance from a resting surface for the washing machine. At least one second luminaire is provided in the bottom, and the light rays shine on the resting surface.

The advantage of this measure is that the visual appearance is substantially improved. Instead of a cubed-shaped appliance that sits on the floor, an aura is created by illuminating the bottom so that the appliance appears to float on a bed of light.

Other advantages of the invention are found in the description and accompanying drawing. Of course, the above-cited features and those listed below can be used in other combinations besides the cited combination, or they can be used by themselves without departing from the scope of the invention.

### BRIEF DESCRIPTION OF THE DRAWINGS

The drawings show exemplary embodiments of the invention that will be further explained in the following description.

FIG. 1 shows a perspective view of an exemplary embodiment of the washing machine according to the invention;

FIG. 2 is a view of a central portion of the front side of washing machine of FIG. 2, in two different states of the washing cycle;

FIG. 3 shows a section of the washing machine from FIG. 1 when the door is closed; and

FIG. 4 shows a section of the washing machine from FIG. 1 when the door is opened.

### DETAILED DESCRIPTION

In FIG. 1 to 4, the number identifies an exemplary embodiment of a washing machine according to the invention as a whole. Of course it is understood that the washing machine is used as an example of the invention for the sake of clarity, and that the measures according to the invention can also be used for other similar household appliances such as dryers, washer/dryers, i.e. combined washing machines and dryers, and spin dryers.

The washing machine has a top 11, two side walls 12, a front 13, a rear wall 14 as well as a bottom 15 that together form an essentially cubed housing 16. The housing 16 encloses an interior 17 in which a drum 18 is located with a horizontal rotary axis 19.

At the top of the front 13, there is a top projection 20 which is provided with various front operating and display elements 21. On the bottom end of the front, there is a bottom projection 22 behind which e.g. a filter or lint trap, etc. is accessible.

Between the projections 20 and 22, there is a door 24 and an opener or handle 26 that can be integrated in the door 24 or in the front 13 of the housing 16. The washing machine 10 is accordingly a front loader. It is also to be understood that this is only an example, because the invention can also be implemented with so-called top loaders in which the drum is accessible from the top of the housing.

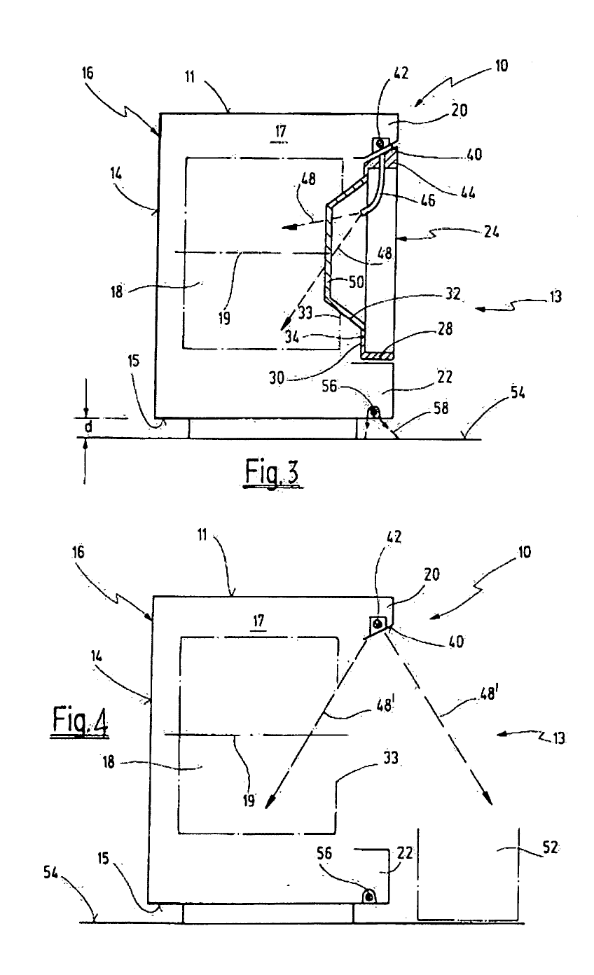

As can be seen particularly well in FIGS. 1 and 3, the door 24 has a frame 28 that encloses a plate 30 which is recessed from the front of the housing 16. A porthole is located in the plate 30, i.e., a pot-shaped element, an axial section of which forms a truncated cone, made of a transparent material. When the door 24 is closed, the rear end of the porthole 32 sits tightly in a front opening 33 of the drum 18. The required seals are not shown for the sake of clarity and are familiar to professionals.

Around the porthole 32 in the plate 30 is a ring-shaped lighting element 34. The lighting element 34 can be a light guide that is fed at one end by one or more light sources such as light-emitting diodes (LEDs) of different colors.

This allows the ring-shaped lighting element 34 to shine in different colors. A control is provided for this (not shown) that assigns different colors to the different operating states of the washing machine 10. For example, the lighting element 34 can be blue during the wash cycle, green during the rinse cycle, and red during the drying cycle (for a washer/dryer). The user can tell at a glance how far the set program has advanced.

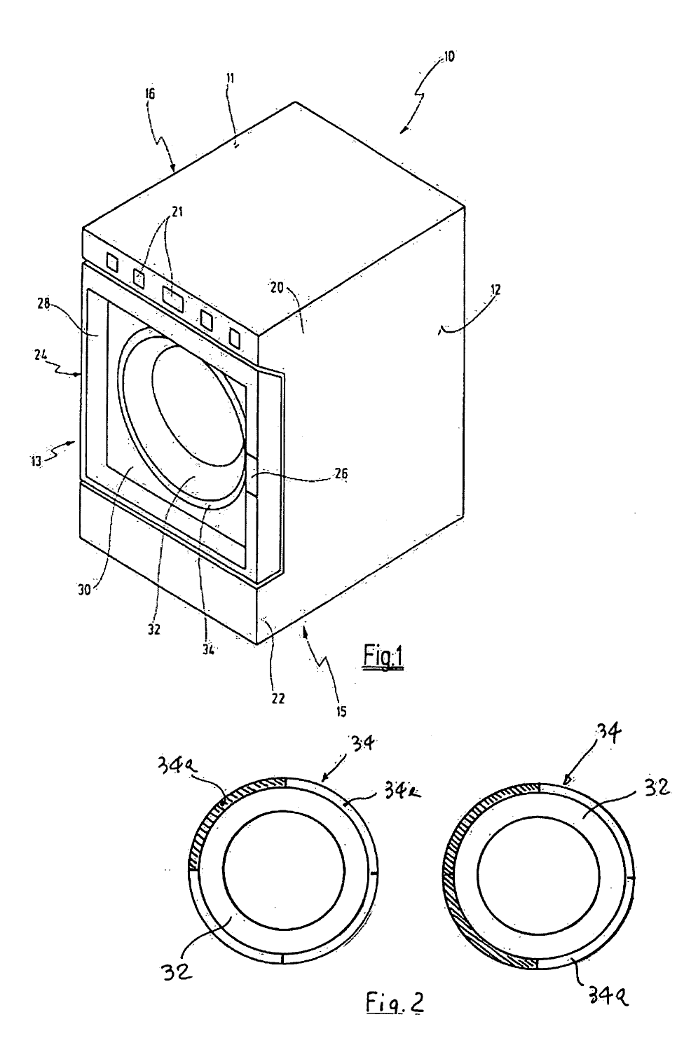

According to another embodiment of the invention (FIG. 2), the ring shaped lighting element 34 is divided in several sectors 34a that are switched in sequence according to the operating state of the washing machine. In this case the user, depending on the number of sectors switched on, can assess immediately, without the need of being close to the washing machine, what is the operating state of the washer (pre-washing, washing, rinsing, spinning, etc.). Moreover, each sector can be of a different color with respect to the others.

The ring-shaped element 34 can be also located around the door, on the front side of the housing, when the washing machine is of the more traditional type, i.e. without the frame 28 shown in FIG. 1. On the other hand, also in this more traditional washing machine having a round door, the ring-shaped lighting element 34 can be integral with the door as well.

A similar same effect of the lighting element 34 can also be attained by illuminating the opener 26 and/or display elements 21 and/or the interior of the drum 19 in the described manner instead of or in addition to the ring-shaped lighting element 34. Luminous films, light bulbs with color filters, laser diodes, etc. can be used as lighting instead of LEDs.

The respectively utilized lighting element can be completely illuminated with the relevant color or divided into sections that are assigned one of the colors. The ring-shaped lighting element 34 can in this case be subdivided into sectors over its perimeter that are each assigned a color which shine in the corresponding operating state.

As can be seen in FIG. 3, the top projection 20 is provided with an angled bottom 40. According to another feature of the invention, a first luminaire 42 is inserted in the bottom 40.

Like the illumination of the ring-shaped lighting element 34, the first luminaire 42 also preferably consists of a light guide that is fed from a long-life lamp such as a LED, a laser diode or another such component. The same lamp can be used for the first luminaire 42 and the lighting element 34, and the light from the lamp is guided through suitable switches and light guides to the respective site at which illumination is desired.

The presently obtainable LED design yields for example a specific life of 100,000 operating hours. Even if only 50,000 operating hours are realistic for the environmental conditions predominating in a washing machine with strongly fluctuating environmental temperature and moisture, this would still be far above the life of a washing machine. This means that the lamp in the washing machine according to the invention can be located anywhere within machine, even at a poorly accessible location, and does not have to be accessible from the outside.

A top section 44 of the frame 28 has a trapezoidal cross-section and lies directly on the angled bottom 40. In section 44, there is a light-guiding element 46 that is designed as a light guide in the portrayed exemplary embodiment. The light guide is led through the section 44. Its top is flush with the top of the section 44, and its bottom end extends downward out of the section 44 and is curved toward the inside of the drum 18. Instead of a curved light guide, a mirror system can also be used.

When the door 24 is closed as in FIG. 3, the light from the first luminaire 42 enters the top of the light-guiding element 46 which is a light guide in the portrayed example. In the described arrangement, the light rays 48 leaving the light-guiding element 46 are approximately parallel to the axis 19 and are directed towards the base 50 of the porthole 32 that optically acts as a plain-parallel plate. The light rays 48 therefore pass essentially uninfluenced through the base 50 and illuminate the inside of the drum 18. The user of the washing machine can therefore observe the processes occurring in the drum 18.

When the door 24 is open as in FIG. 4, the light rays 48′ from the first luminaire 42 proceeded directly downward. This illuminates the interior of the drum 18; on the other hand, an area in front of the washing machine 10 is also illuminated where there is normally a laundry basket 52, etc. The washing machine user can therefore load and unload the washing machine under sufficient light.

The type of illumination is therefore independently adapted to the respective situation depending on the position of the door 24.

We can also see in FIG. 3 that the housing 16 of the washing machine 10 is not directly on a resting surface, i.e. a floor, but is raised above the resting surface by a distance d. This can be achieved by a pedestal or suitable feet that are preferably designed longer than normal feet serving to adjust height. In the area where the bottom 15 projects above the pedestal or feet, there is at least one second luminaire 56 in the bottom whose light rays 58 are directed downward and preferably angled outward. This form of illumination creates the visual impression that the washing machine 10 is hovering above the floor 54.

Among the operating elements 21 is an element that can be used to cause the drum 18 to rotate slowly when the door 24 is open. The user of the washing machine 10 can thereby make sure that no small articles of laundry remain in the drum when unloading the drum 18. In conventional washing machines in which the drum is blocked when the door is open, such an item of laundry, (e.g. a sock) can adhere to the top inside the drum and therefore not be noticed when emptying the drum. If whites are subsequently washed at high temperature, the remaining item of laundry can discolor the whites. If the drum is contrastingly rotated slowly when the door is open, such a remaining item of laundry will fall to the floor of the drum or at least be discovered.

1. A washing machine, comprising:
a housing with a door in a front side of the housing, with a drum located in the housing whose interior is accessible through the door, and with at least one display element for providing information on the operating state of the washing machine,
wherein the at least one display element is designed as a luminous element located on the front side of the housing.

2. The washing machine of claim 1, wherein the luminous element is located on or around the door.

3. The washing machine of claim 1, wherein the luminous element is illuminated in a specific color depending on the operating state to be displayed.

4. The washing machine of claim 1, wherein the display element is provided for different operating states, and the display element is illuminated in different colors as a function of the operating state to be displayed.

5. The washing machine of claim 4, wherein the display element is designed as an essentially ring-shaped lighting element and is mounted on or around a door of the housing.

6. The washing machine of claim 5, wherein the lighting element is essentially ring-shaped and it surrounds a window in the door.

7. The washing machine of claim 6, wherein the ring-shaped lighting element is concentrically arranged around a porthole in the door.

8. The washing machine of claim 1, further comprising:
a second display element provided for different operating states, and the second display element can be illuminated in a specific color depending on the predetermined operating state to be displayed.

9. The washing machine of claim 8, wherein the second display element is designed as sections of a structurally unified display element that can be illuminated differently.

10. The washing machine of claim 9, wherein the structurally unified display element is designed as an essentially ring-shaped lighting element and is located on or around a door of the housing, whereby the sections are designed as sectors of the lighting element.

11. The washing machine of claim 10, wherein the lighting element is ring-shaped and is concentrically disposed around a porthole in the door.

12. The washing machine of claim 1, wherein the luminous elements are supplied with light via light guides.

13. The washing machine of claim 1, further comprising:
a luminaire from which light rays shine into the drum, whereby the luminaire is located in the front of the housing, wherein a light-guiding element is provided in the door and the arrangement is such that when the door is open, the light rays shine into the drum as well as onto an area in front of the side, and when the door is closed, the light-guiding element is in front of the luminaire, and the light rays are guided through the light-guiding element into the drum.

14. The washing machine of claim 13, wherein the light-guiding element contains a light guide.

15. The washing machine of claim 14, wherein the light guide is curved.

16. The washing machine of claim 13, wherein the light-guiding element contains a mirror.

17. The washing machine of claim 13, wherein the door has a pot-shaped porthole with an essentially flat base, and the light rays pass through the base when the door is closed.

18. The washing machine of claim 13, wherein the housing has a bottom that is at a distance from a resting surface for the washing machine, wherein there is at least one second luminaire provided in the bottom whose light rays shine on the resting surface.
